(19) United States
(12) Patent Application Publication
(10) Pub. No.: US 2025/0199106 A1
(43) Pub. Date: Jun. 19, 2025

(54) MAGNETOSTRICTIVE POSITION MEASUREMENTS BASED ON LONGITUDINAL AND TORSIONAL WAVES

(71) Applicant: TEMPOSONICS, LLC, Cary, NC (US)

(72) Inventor: Uwe Viola, Cary, NC (US)

(21) Appl. No.: 18/980,221

(22) Filed: Dec. 13, 2024

Related U.S. Application Data
(60) Provisional application No. 63/610,931, filed on Dec. 15, 2023.

(51) Int. Cl. G01S 1/72; B06B 1/08; G01B 7/00

(52) U.S. Cl. CPC G01S 1/72; B06B 1/085; G01B 7/003

(57) ABSTRACT

A magnetostrictive position measuring system includes a waveguide, an excitation generator configured to generate an excitation signal, a target magnet configured to generate a magnetostrictive response in response to the excitation signal, one or more sensing elements and a controller. The sensing elements are configured to generate at least one electrical response signal based on the magnetostrictive response that includes a longitudinal wave indicator and a torsional wave indicator. The controller is configured to identify the longitudinal wave and torsional wave indicators, calculate a first candidate position of the target magnet along the longitudinal axis based on the longitudinal wave indicator, calculate a second candidate position of the target magnet along the longitudinal axis based on the torsional wave indicator and generate an output based on the first and second candidate positions.

### CROSS-REFERENCE TO RELATED APPLICATIONS

This application claims the benefit of priority from U.S. Provisional Patent Application No. 63/610,931, filed Dec. 15, 2023 for “Magnetostrictive Position Measurements Based on Longitudinal and Torsional Waves,” the content of which is hereby incorporated by reference.

### FIELD

Embodiments of the present disclosure generally relate to magnetostrictive position measurement, and more specifically, to magnetostrictive position measuring systems and methods that utilize both longitudinal and torsional waves of magnetostrictive responses.

### BACKGROUND

Magnetostrictive position measurement systems or linear position transducers are robust, high resolution instruments which have proven to be useful in many measurement and control applications. Magnetostrictive linear position systems generally include a wire waveguide and a target magnet that has a position that can vary relative to the waveguide. The location of the target magnet along the waveguide corresponds to the position to be measured.

An excitation generator of the magnetostrictive position measurement system generates an electrical excitation signal, such as a current pulse, which is conducted through the waveguide. This creates a magnetic field around the waveguide that interacts with the magnetic field of the target magnet to produce a magnetostrictive response in the waveguide at the location of the target magnet. The magnetostrictive response takes the form of a sonic wave having mechanical pulse components including a longitudinal wave corresponding to a compression of the waveguide along its longitudinal axis, and a torsional wave corresponding to a torsional strain on the surface of the waveguide about the longitudinal axis.

A transducer or sensing element of the magnetostrictive position measurement system located at an end of the waveguide is used to detect the longitudinal wave or torsional wave by converting the wave into an electrical response signal. The electrical response signal is processed to determine the position of the target magnet based on a time of flight measurement between the excitation signal and a detection of the longitudinal wave or the torsional wave.

### SUMMARY

Embodiments of the present disclosure are directed to magnetostrictive position measuring systems that utilize both longitudinal and torsional waves of magnetostrictive responses and methods performed by the systems.

One example of a magnetostrictive position measuring system includes a waveguide having a longitudinal axis, an excitation generator, a target magnet, one or more sensing elements and a controller. The excitation generator is configured to transmit an excitation signal through the waveguide. The target magnet is moveable along the longitudinal axis relative to the waveguide and is configured to generate a magnetostrictive response in the waveguide in response to the excitation signal. The magnetostrictive response includes a longitudinal wave and a torsional wave. The one or more sensing elements are configured to generate at least one electrical response signal comprising a longitudinal wave indicator, which is generated in response to the longitudinal wave, and a torsional wave indicator, which is generated in response to the torsional wave. The controller is connected to the one or more sensing elements and is configured to process the at least one electrical response signal to identify the longitudinal wave and torsional wave indicators. The controller is also configured to calculate a first candidate position of the target magnet along the longitudinal axis based on the longitudinal wave indicator, calculate a second candidate position of the target magnet along the longitudinal axis based on the torsional wave indicator and generate an output based on the first and second candidate positions.

In one embodiment, the magnetostrictive position measuring system according to claim 1, wherein the controller is configured to compare the first and second candidate positions, and generate the output based on the comparison of the first and second candidate positions.

In one embodiment, the controller calculates the first candidate position based on a period of time from the transmission of the excitation signal to a time corresponding to the identified longitudinal wave indicator, and the controller calculates the second candidate position based on a period of time from the transmission of the excitation signal to a time corresponding to the identified torsional wave indicator.

In one embodiment, the controller is configured to estimate a time location of the torsional wave indicator in the at least one electrical response signal based on the identified longitudinal wave indicator, and process the at least one electrical response signal beginning from a time location that is based on the estimated time location of the torsional wave to identify the torsional wave indicator.

In one embodiment, the controller is configured to analyze samples of the at least one electrical signal to identify the longitudinal wave indicator, and analyze samples of the at least one electrical signal beginning from the estimated time location to identify the torsional wave indicator.

In one embodiment, the controller is configured to estimate a time location of the longitudinal wave indicator in the at least one electrical response signal based on the identified torsional wave indicator, and process the at least one electrical response signal beginning from a time location that is based on the estimated time location of the longitudinal wave to identify the longitudinal wave indicator.

In one embodiment, the one or more sensing elements comprise at least one transducer configured to generate the at least one electrical response signal.

In one embodiment the at least one transducer comprises a magnet and a coil, wherein relative movement between the magnet and the coil in response to the magnetostrictive response generates one of the at least one electrical response signal in the coil, and/or a piezoelectric material configured to generate one of the at least one electrical response signal in response to a mechanical stress on the piezoelectric material caused by the magnetostrictive response transmitted through the waveguide.

In one embodiment, the output includes an indication of at least one of a match between the first and second candidate positions and a mismatch between the first and second candidate positions.

In one embodiment, the output includes an indication of at least one of a degree of match between the first and second candidate positions and a degree of mismatch between the first and second candidate positions.

In one example of a method of determining a position of a target magnet that is moveable relative to a waveguide along a longitudinal axis of the waveguide, an excitation signal is transmitted using an excitation generator through the waveguide toward the target magnet, in response to the excitation signal, a magnetostrictive response of the target magnet is generated in the waveguide. The magnetostrictive response includes a longitudinal wave and a torsional wave. The longitudinal and torsional waves are sensed in the waveguide using one or more sensing elements, and at least one electrical response signal is generated using the one or more sensing elements in response to the sensing. The at least one electrical response signal includes a longitudinal wave indicator and a torsional wave indicator. The longitudinal wave indicator is identified in the at least one electrical response signal using a controller. The torsional wave indicator in the at least one electrical response signal using the controller. A first candidate position of the target magnet along the longitudinal axis is calculated based on the identified longitudinal wave indicator using the controller. A second candidate position of the target magnet along the longitudinal axis is calculated based on the identified torsional wave indicator using the controller. An output is generated based on the first and second candidate positions using the controller.

In one embodiment, the method includes comparing the first and second candidate positions using the controller, and generating the output comprises generating the output based on the comparison of the first and second candidate positions.

In one embodiment, calculating the first candidate position comprises determining a period of time from the transmission of the excitation signal to a time corresponding to the identified longitudinal wave indicator, and calculating the second candidate position comprises determining a period of time from the transmission of the excitation signal to a time corresponding to the identified torsional wave indicator.

In one embodiment, identifying the torsional wave indicator comprises estimating a time location of the torsional wave indicator in the at least one electrical response signal based on the identified longitudinal wave indicator, and processing the at least one electrical response signal beginning from a time location that is based on the estimated time location of the torsional wave to identify the torsional wave indicator.

In one embodiment, identifying the longitudinal wave indicator comprises analyzing samples of the at least one electrical signal to identify the longitudinal wave indicator, and identifying the torsional wave indicator comprises analyzing samples of the at least one electrical signal beginning from the estimated time location.

In one embodiment, identifying the longitudinal wave indicator comprises estimating a time location of the longitudinal wave indicator in the at least one electrical response signal based on the identified torsional wave indicator, and processing the at least one electrical response signal beginning from a time location that is based on the estimated time location of the longitudinal wave to identify the longitudinal wave indicator.

In one embodiment, the one or more sensing elements comprise at least one transducer configured to generate the at least one electrical response signal.

In one embodiment, the at least one transducer comprises a magnet and a coil, wherein relative movement between the magnet and the coil in response to the magnetostrictive generates one of the at least one electrical response signal in the coil, and/or a piezoelectric material configured to generate one of the at least one electrical response signal in response to a mechanical stress on the piezoelectric material caused by the magnetostrictive response transmitted through the waveguide.

In one embodiment, the output includes an indication of at least one of a match between the first and second candidate positions and a mismatch between the first and second candidate positions.

In one embodiment, the output includes an indication of at least one of a degree of match between the first and second candidate positions and a degree of mismatch between the first and second candidate positions.

Another example of a magnetostrictive position measuring system includes a waveguide having a longitudinal axis, an excitation generator configured to transmit an excitation signal through the waveguide, a first target magnet that is moveable along the longitudinal axis relative to the waveguide and is configured to generate a first magnetostrictive response including a longitudinal wave in the waveguide in response to the excitation signal, and a second target magnet that is moveable along the longitudinal axis relative to the waveguide and is configured to generate a second magnetostrictive response including a torsional wave in the waveguide in response to the excitation signal. The system also includes one or more sensing elements configured to sense the first and second magnetostrictive responses in the waveguide and generate at least one electrical response signal that includes a longitudinal wave indicator corresponding to the longitudinal wave and a torsional wave indicator corresponding to the torsional wave. A controller of the system is configured to process the at least one electrical response signal to identify the longitudinal and torsional wave indicators, calculate a position of the first target magnet along the longitudinal axis based on the identified longitudinal wave indicator, calculate a position of the second target magnet along the longitudinal axis based on the identified torsional wave indicator, and generate an output indicating the calculated positions of the first and second target magnets.

In one embodiment, the controller calculates the position of the first target magnet based on a period of time from the transmission of the excitation signal to a time corresponding to the identified longitudinal wave indicator, and the controller calculates the position of the second target magnet based on a period of time from the transmission of the excitation signal to a time corresponding to the identified torsional wave indicator.

In one embodiment, the first target magnet is displaced from the waveguide a greater radial distance than the second target magnet.

In one embodiment, the first target magnet is configured to move along the longitudinal axis from a first side of the second target magnet along the longitudinal axis to a second side of the target magnet along the longitudinal axis that is opposite the first side.

In one embodiment, the first target magnet produces a weaker magnetic field at the waveguide than the second target magnet.

In one embodiment, the one or more sensing elements comprise at least one transducer configured to generate the at least one electrical response signal.

In one embodiment, the at least one transducer comprises a magnet and a coil, wherein relative movement between the magnet and the coil in response to the magnetostrictive response generates one of the at least one electrical response signal in the coil, and/or a piezoelectric material configured to generate one of the at least one electrical response signal in response to a mechanical stress on the piezoelectric material caused by the magnetostrictive response transmitted through the waveguide.

In a method performed by a magnetostrictive position measuring system to determine positions of first and second target magnets along a longitudinal axis of a waveguide, an excitation signal is transmitted through the waveguide using an excitation generator, and a first magnetostrictive response of the first target magnet and a second magnetostrictive response of the second magnet are generated in the waveguide in response to the excitation signal. The longitudinal and torsional waves in the waveguide are sensed using one or more sensing elements, and at least one electrical response signal is generated using the one or more sensing elements in response to the sensing. The at least one electrical response signal comprising a longitudinal wave indicator corresponding to the longitudinal wave and a torsional wave indicator corresponding to the torsional wave. The longitudinal wave and torsional wave indicators are identified in the at least one electrical response signal using a controller. A position of the first target magnet along the longitudinal axis is calculated based on the identified longitudinal wave indicator using the controller. A position of the second target magnet along the longitudinal axis is calculated based on the identified torsional wave indicator using the controller. An output indicating the calculated positions of the first and second target magnets is generated using the controller.

In one embodiment, calculating the position of the first target magnet comprises determining a period of time from the transmission of the excitation signal to a time corresponding to the identified longitudinal wave indicator, and calculating the position of the second target magnet comprises determining a period of time from the transmission of the excitation signal to a time corresponding to the identified torsional wave indicator.

In one embodiment, the first target magnet is displaced from the waveguide a greater radial distance than the second target magnet.

In one embodiment, the first target magnet is configured to move along the longitudinal axis from a first side of the second target magnet along the longitudinal axis to a second side of the target magnet along the longitudinal axis that is opposite the first side.

In one embodiment, the first target magnet produces a weaker magnetic field at the waveguide than the second target magnet.

In one embodiment, the one or more sensing elements comprise at least one transducer configured to generate the at least one electrical response signal.

In one embodiment, the at least one transducer comprises a magnet and a coil, wherein relative movement between the magnet and the coil in response to the magnetostrictive response generates one of the at least one electrical response signal in the coil, and/or a piezoelectric material configured to generate one of the at least one electrical response signal in response to a mechanical stress on the piezoelectric material caused by the magnetostrictive response transmitted through the waveguide.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a schematic pictorial view of an example of a magnetostrictive position measuring system in accordance with embodiments of the present disclosure.

FIG. 2 is a simplified circuit diagram of an example of a magnetostrictive position measuring system in accordance with embodiments of the present disclosure.

FIGS. 3A-D are simplified isometric views of examples of magnetostrictive response pickups utilizing various sensing elements, in accordance with embodiments of the present disclosure.

FIG. 4 is a chart illustrating an example of a portion of an electrical response signal over time in accordance with embodiments of the present disclosure.

FIG. 5 is a flowchart illustrating a method performed by the magnetostrictive position measuring system to determine a position of a target magnet relative to a waveguide in accordance with embodiments of the present disclosure.

FIG. 6 is a flowchart illustrating an example of a method of identifying longitudinal and torsional indicators in an electrical response signal in accordance with embodiments of the present disclosure.

FIGS. 7A and 7B are simplified diagrams illustrating a portion of the magnetostrictive position measuring system of FIG. 1 in accordance with embodiments of the present disclosure.

FIGS. 8A and 8B are charts illustrating examples of a portion of an electrical response signal over time in accordance with embodiments of the present disclosure.

FIG. 9 is a flowchart illustrating an example of a method of operating a magnetostrictive position measuring system having dual target magnets in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the specific embodiments set forth herein. Rather, embodiments are described so that this disclosure will be thorough and complete, and will fully convey the scope of the embodiments to those skilled in the relevant art.

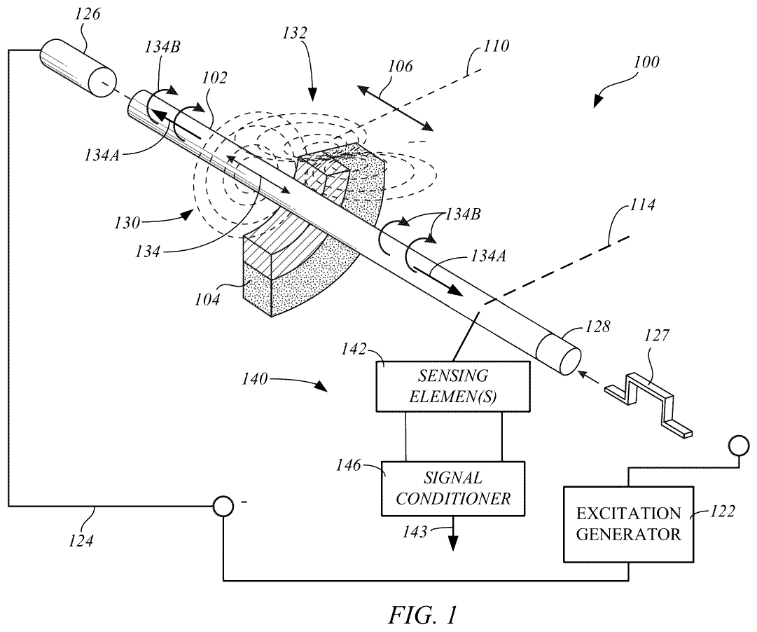

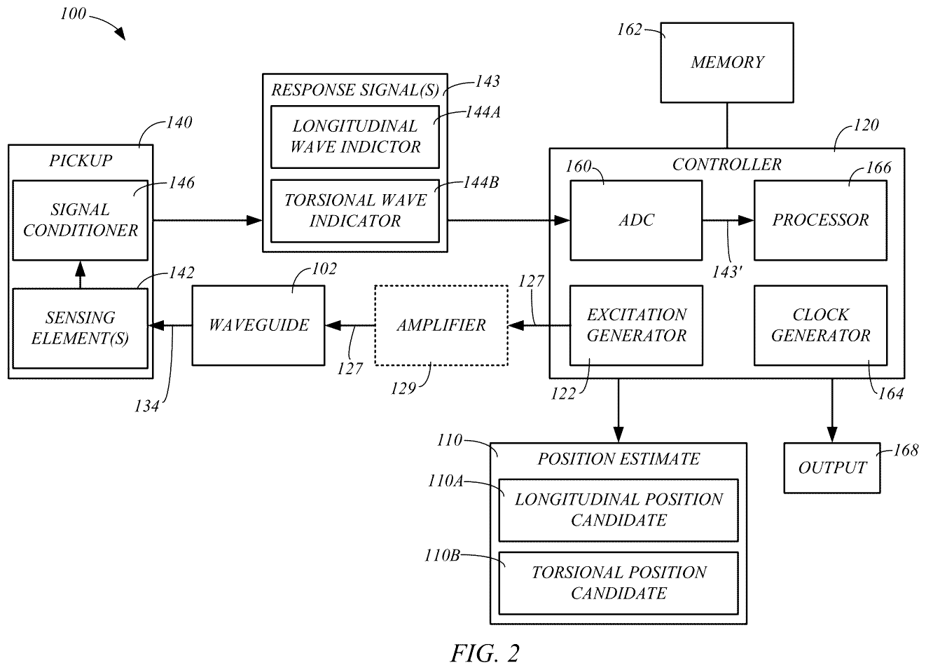

FIGS. 1 and 2 respectively are a schematic pictorial view and a simplified circuit diagram of an example of a magnetostrictive position measuring system 100, in accordance with embodiments of the present disclosure. The system 100 includes a wire having magnetoelastic properties, referred to as a waveguide 102 and one or more target magnets 104 (one of which is indicated in FIG. 1) located adjacent to the waveguide 102 and/or surrounding the waveguide 104.

Each target magnet 104 is moveable relative to the waveguide 102 along an axis 106 and has a position 110 along the axis 106 from a reference position 114 that is to be detected by the system 100. Each target magnet 104 can move independently along the waveguide 102 and may comprise one or more magnets (e.g., permanent magnets or electromagnets), such as a single magnet or a stack of magnets.

A controller 120 (FIG. 2) of the system 100 includes an excitation generator 122. A closed electrical circuit may be formed by the generator 122, the waveguide 102, and a return wire 124 that connects the end 126 of the waveguide 102 back to the excitation generator 122, as shown in FIG. 1. The generator 122 may be in the form of an electric pulse generator that generates an electrical excitation signal in the form of an electrical current pulse 127, which is delivered to an end 128 of the waveguide 102. An amplifier 129 (FIG. 2) may be used to amplify the electrical pulse 127 before applying it to the waveguide 102.

The transmission of the electrical pulse 127 through the waveguide 102 generates a magnetic field 130 that interacts with the magnetic field 132 of the magnet 104 to generate a mechanical magnetostrictive response (e.g., acoustic waves) 134 in the waveguide 102, which includes a longitudinal wave 134A (e.g., longitudinal compression) and a torsional wave 134B (e.g., torsional strain) in the waveguide 104, as indicated in FIG. 1.

The magnetostrictive response 134 travels from both sides of the magnet 104 along the waveguide 102. For example, a portion of the magnetostrictive response 134 may travel along the waveguide 102 from the position 110 of the magnet 104 toward the end 126 of the waveguide 102 and possibly to a damper (not shown) that reduces or eliminates propagation of the acoustic waves back through the waveguide 102. Additionally, a portion of the magnetostrictive response 134 travels from the position 110 of the magnet 104 toward the end 128 of the waveguide, at which a magnetostrictive response pickup 140 is used to sense the response 134.

The magnetostrictive response pickup 140 includes one or more sensing elements 142. The sensing elements 142 are configured to sense the magnetostrictive response 134 and generate at least one electrical response signal 143 that is based on the magnetostrictive response 134. That is, the electrical response signal or signals 143 includes an indicator 144A of the longitudinal wave 134A and an indicator 144B of the torsional wave 134B, as indicated in FIG. 2. For instance, each indicator may comprise a transient change or pulse in the magnitude of the signal 143. A signal conditioner 146 of the pickup 140 may be used to amplify or otherwise condition (e.g., filter the signal from sensing elements 142) so as to generate the one or more electrical response signals 143 prior to their delivery to the controller 120, as indicated in FIG. 2. The position of each target magnet 104 along the axis 106 relative to the waveguide 102 may be determined based on the indicators 144A and 144B.

The one or more sensing elements 142 may comprise a single sensing element that is configured (e.g., “tuned”) to sense both the longitudinal wave 134A and the torsional wave 134B and produce an electrical response signal 143 (which may be conditioned) containing the indicators 144A and 144B corresponding to both waves 134A and 134B. Alternatively, the sensing elements 142 may comprise a sensing element that is configured to sense the longitudinal wave 134A and produce a response signal 143 that includes the longitudinal wave indicator 144A, and the another sensing element that is configured to sense the torsional wave 134B and produce a response signal 143 that includes the torsional wave indicator 144B.

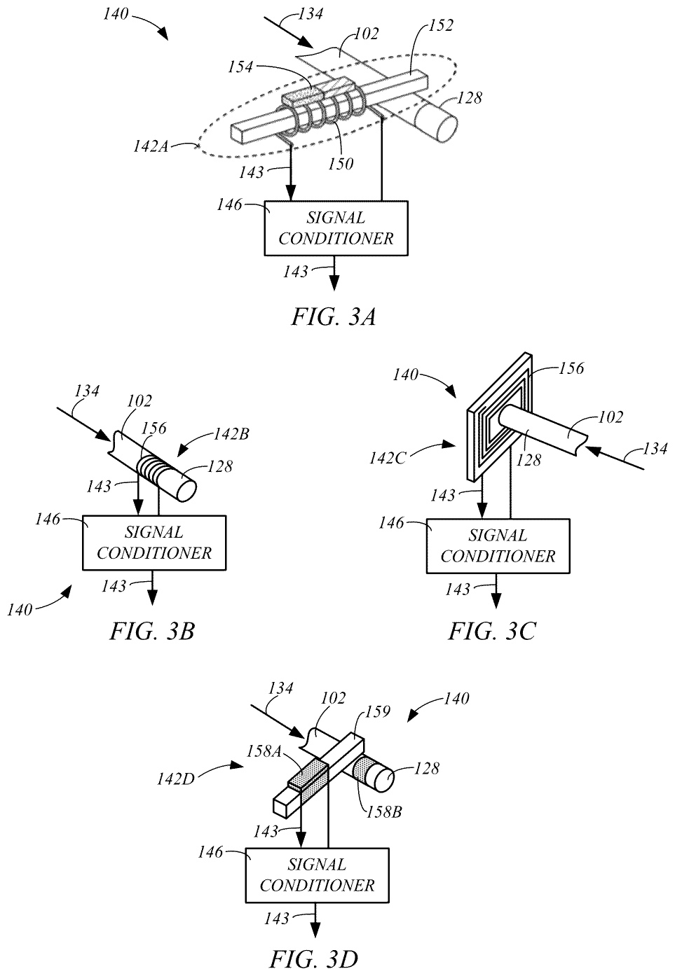

FIGS. 3A-D are isometric views of examples of pickups 140 of the system 100 having various sensing elements 142, in accordance with embodiments of the present disclosure. One example of a sensing element 142A includes a coil 150 that is attached to the waveguide 102, such as through a rigid member 152, as shown in FIG. 3A. A magnet 154 has a magnetic field that surrounds the coil 150. When the magnetostrictive response 134 (e.g., longitudinal wave or torsional wave) traveling through the waveguide 102 reaches the member 152, the member 152 vibrates causing relative movement between the magnetic field and the coil 150. The magnetic field induces a current pulse in the coil 150, which forms the indicator 144 of the response 134 in the electrical response signal 143 traveling through the coil 150. The signal 143 from the coil 150 may be processed by the signal conditioner 146 before reaching the controller 120 (FIG. 2).

One alternative to this arrangement is to form the member 152 out of a magnetic material and support the coil 150 in a manner that allows the magnetic member 152 to move relative to the coil 150. Thus, when the magnetic member 152 vibrates in response to the magnetostrictive response 134, a corresponding current pulse indicator is induced in the electrical response signal 143 from the coil 150 due to the movement of the magnetic field relative to the coil 150.

FIGS. 3B-D respectively illustrate other examples of suitable sensing elements 142B-D, in accordance with embodiments of the present disclosure. The sensing element may include a conductive coil 156 that is wrapped around the waveguide 102, as shown in the sensing element 142B (FIG. 3B) or is oriented in a plane that is generally perpendicular to the waveguide 102, as shown in the sensing element 142C (FIG. 3C). In each case, the magnetostrictive response 134 traveling through the waveguide induces a current pulse or indicator 144 of the response 134 in the coil 156.

The example sensing element 142D shown in FIG. 3D comprises a piezoelectric material 158 that is connected to the waveguide 102 and is configured to be physically strained in response to the magnetostrictive response 134. The strain on the piezoelectric material 158 produces a current pulse in the response signal 143 that forms an indicator 144 of the response 134. The piezoelectric material 158 may be exposed to the magnetostrictive response 134 through a piezoelectric material 158A that is connected to a side of the waveguide through a rigid member 159, or a piezoelectric material 158B that is connected to or in line with the waveguide 102, for example.

Other suitable sensing elements may include an XMR sensor (see, e.g., U.S. Pat. No. 9,816,843), or other conventional sensing elements.

The controller 120 may process the one or more response signals 143 using any suitable technique. In one example, the controller 120 includes an analog-to-digital converter (ADC) 160 that converts each of the one or more analog electrical response signals 143 into corresponding digital samples 143′. For example, the ADC 160 may sample each of the one or more analog response signals 143 at a frequency that allows the response signal 143 to be further processed by the controller 120. The digital samples 143′ of each response signal 143 may be stored in a memory 162 of the system 100 or a buffer of the controller 120, for example.

The controller 120 may include a clock generator 164 that begins a timing routine when the magnetostrictive excitation is generated by the excitation generator 122, such as when the electrical current pulse 127 is generated. The clock generator 164 may be used to determine the time of each digital sample relative to the generation of the magnetostrictive excitation.

The controller 120 may comprise one or more processors 166 that control components of the system 100, and/or perform one or more functions described herein in response to the execution of instructions, which may be stored locally in non-transitory memory 162 or computer-readable media (e.g., flash memory, optical data storage, magnetic data storage, etc.) of the system 100. In some embodiments, each processor 166 of the controller 120 may comprise one or more computer-based systems, control circuits, microprocessor-based engine control systems, and/or programmable hardware components (e.g., field programmable gate array), for example.

In some embodiments, the at least one processor 166 is configured to analyze the digital samples of each digital response signal 143′ to detect the indicator of the longitudinal wave 134A and the indicator of the torsional wave 134B, and establish the time of flight for the waves 134A and 134B to travel from the unknown position 110 of the target magnet 104 to the reference position 114 at the sensing element(s) 140 based on the known speeds at which the longitudinal wave 134A and the torsional wave 134B travel through the waveguide 102. In some embodiments, the controller 120 is configured to calculate a longitudinal position candidate 110A of each target magnet 104 along the axis 106 of the waveguide 102 based on the time of flight of the longitudinal wave 134A, and a torsional position candidate 110B of the target magnet 104 along the axis 106 of the waveguide 102 based on the time of flight of the torsional wave 134B.

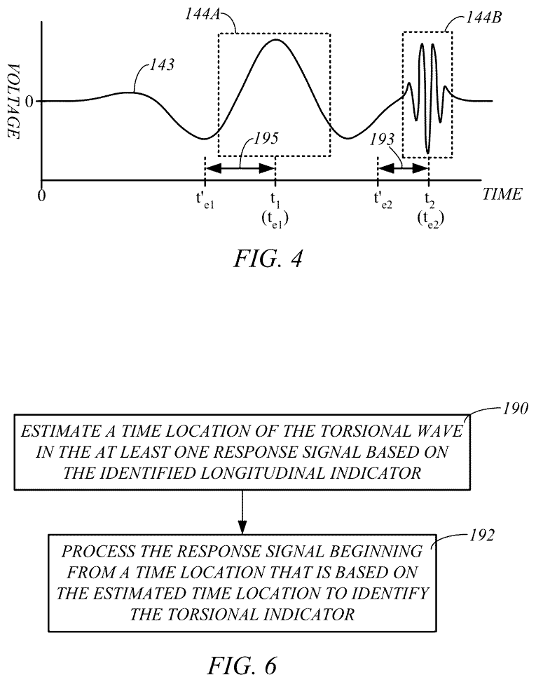

FIG. 4 is a chart illustrating an example of a voltage of a portion of a response signal 143 over time corresponding to a magnetostrictive response 134 generated by the reference magnet 104 (FIG. 1). The example response signal 143 includes a longitudinal wave indicator 144A of the longitudinal wave 134A and a torsional wave indicator 144B of the torsional wave 134B. The response signal 143 may be a composite of two response signals from different sensing elements 142, each including one of the indictors 144A or 144B or a single response signal from a single sensing element 142 that includes both indicators 144A and 144B.

The longitudinal wave 134A travels through the waveguide 102 at a faster speed than the torsional wave 134B and may have a frequency of about 25 kHz, while the torsional wave 134B has a frequency of about 250 kHz. As a result, the longitudinal wave 134A is generally received by the sensing element(s) 142 before the torsional wave 134B, and the longitudinal wave indicator 144A is detected earlier in time than the torsional wave indicator 144B, as indicated in FIG. 4.

The controller 120 may calculate the longitudinal position candidate 110A of the target magnet 104 based on a time of flight t₁ (FIG. 4) corresponding to the longitudinal wave indicator 144A, which is the period of time from the transmission of the excitation signal 127 by the generator 122 to the sensing of the longitudinal wave indicator 144A, and the known speed of the longitudinal wave 134A through the waveguide 102. The controller 120 may also calculate the torsional position candidate 110B based a time of flight t₂ (FIG. 4) corresponding to the torsional wave indicator 144B, which is the period of time from the transmission of the excitation signal 127 to the sensing of the torsional wave indicator 144B, and the known speed of the torsional wave 134B through the waveguide 102. The times t₁ and t₂ may be identified by the controller 120 in accordance with conventional techniques, such as based on a voltage of the response signal 143 exceeding a threshold value at a leading or trailing edge of the indicators 144, for example. The calculations of the position candidates 110A and 110B based on the times t₁ and t₂ may also be made in accordance with conventional techniques and output by the controller 120, as indicated in FIG. 2.

Some embodiments of the present disclosure relate to the utilization of both the longitudinal wave indicator 144A and the torsional wave indicator 144B to check the validity of the position measurement and/or that the system 100 is operating properly. In some embodiments, the controller 120 (e.g., one or more of the processors 166), is configured to compare the longitudinal position candidate 110A to the torsional position candidate 110B, and generate an output 168 based on the comparison, as indicated in FIG. 2.

The output 168 may include an indication of a match and/or a mismatch between the longitudinal position candidate 110A and the torsional position candidate 110B. A match indicates that the system 100 is operating properly, while a mismatch indicates that there may be a problem with the measurement, such as an error in the response signal 143 (e.g., interference or noise), a malfunction in the system 100 (e.g., issue with the target magnet or pickup, etc.), or another issue with the system or measurement. In some embodiments, the match or mismatch between the candidates 110A and 110B may be determined based on a value difference between the candidates, or whether the difference between the candidates exceeds a predetermined threshold.

The output 168 may include an indication of the degree of a match and/or mismatch, such as by indicating the difference between the candidates, or whether the difference exceeds the predetermined threshold, for example. When a mismatch is found, the output 168 may include a notification, such as an alarm, an error message, etc., which may indicate an error in the measurement or a fault in the system 100, for example.

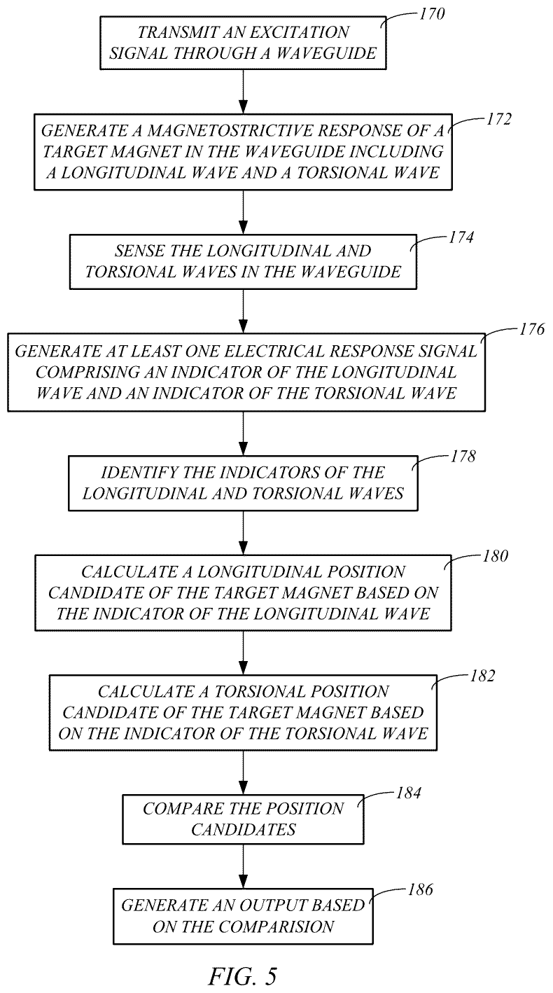

FIG. 5 is a flowchart illustrating a method performed by the system 100 to determine a position of the target magnet 104 relative to the waveguide 102 along the longitudinal axis 106, in accordance with embodiments of the present disclosure. At 170 of the method, an excitation signal 127 is transmitted using the excitation generator 122 through the waveguide 102 toward the target magnet 104 and, in response to the excitation signal 127, a magnetostrictive response 134 of the target magnet 104 is generated by interaction of the magnetic fields of the excitation signal 127 and the target magnet 104 in the waveguide 102 and transmitted through the waveguide 102, at 172. The magnetostrictive response 134 includes a longitudinal wave 134A and a torsional wave 134B.

At 174, the longitudinal and torsional waves 134A and 134B are sensed using one or more sensing elements 142, which generate at least one electrical response signal 143 at 176 of the method. The at least one electrical response signal 143 comprises a longitudinal wave indicator 144A of the longitudinal wave 134A and a torsional wave indicator 144B of the torsional wave 134B.

At 178, the longitudinal wave indicator 144A and the torsional wave indicator 144B in the at least one electrical response signal 143 are identified using the controller 120 (e.g., the at least one processor 166). These identifications may comprise the time of flight t₁ corresponding to the longitudinal wave indicator 144A and the time of flight t₂ corresponding to the torsional wave indicator 144B, examples of which are shown in FIG. 4.

A longitudinal position candidate 110A of the target magnet 104 along the longitudinal axis 106 is calculated by the controller 120 (e.g., the at least one processor 166) based on the identified longitudinal wave indicator 144A, at 180. At 182, a torsional position candidate 110B of the target magnet 104 along the longitudinal axis 106 is calculated based on the identified indicator of the torsional wave using the controller 120 (e.g., the at least one processor 166).

The longitudinal position candidate 110A and the torsional position candidate 110B are compared (step 184), and an output 168 is generated (step 186) based on the comparison using the controller 120 (e.g., the at least one processor 166). As mentioned above, the output 168 may indicate a match or mismatch, include a notification, etc., as discussed above.

Some embodiments of the present disclosure are directed to methods that operate to identify the indicators 144 more efficiently than when the response signal(s) 143 is fully analyzed to detect the indicators 144A and 144B. In general, the methods involve using the detection of one of the indicators 144A or 144B to reduce the number of samples 143′ that must be analyzed to identify the other indicator 144A or 144B. This results in a reduction in the memory and processing resources of the controller 120 that are required to identify both indicators 144A and 144B.

FIG. 6 is a flowchart illustrating an example of the method, in accordance with embodiments of the present disclosure. At 190 of the method, the controller 120 estimates a time location tₑ of the torsional wave indicator 144B in the at least one response signal based on the longitudinal wave indicator 144A identified in step 178 (FIG. 5). Since both indicators 144A and 144B relate to the same target magnet location 110 (FIG. 1), the controller 120 uses the time t₁ corresponding to the longitudinal wave indicator 144A to calculate the longitudinal position candidate 110A (step 180). Since the speed of the torsional wave 134B through the waveguide 102 is known, the controller 120 estimates the time tₑ₂ of the torsional wave indicator 144B by dividing the distance the target magnet 104 is located from the sensing element(s) 142 indicated by the longitudinal candidate position 110A by the speed of the torsional wave 134B.

At 192, the controller 120 processes the response signal 143 that contains the torsional wave indicator 144B beginning from a time location t′ₑ₂ that is based on the estimated time location tₑ₂ to identify the torsional wave indicator 144B (time t₂) in step 178. Since the estimated time location tₑ₂ is likely to be near the time location t₂ of the indicator 144B, as indicated in FIG. 4, in some embodiments, the time location t′ₑ₂ is set near, but earlier than the estimated time location tₑ₂. For example, the time location t′ₑ₂ may be set at a predetermined time offset 193 from the precise estimate tₑ₂ that is calculated in step 190, as shown in FIG. 4. This increases the likelihood that the controller 120 processes a range of the samples 143′ of the response signal 143 that contains the torsional wave indicator 144B while avoiding the processing of the entire response signal 143 or its samples 143′. In some embodiments, the predetermined time offset 193 is approximately 35 μs or more, such as 35-65 μs or around 50 μs (+/−10 μs).

The method of FIG. 5 may then continue with step 182, in which the torsional candidate position 110B is calculated based on the identified time t₂ of the torsional wave indicator 144B and the known speed of the torsional wave 134A.

This same process may also be used to estimate the time location tₑ₁ of the longitudinal wave indicator 144A based on the identified torsional wave indicator 144B and its time location t₂. Here, the torsional position candidate 110B of the target magnet 104 is calculated (step 178) based on the time of flight t₂ and the speed of the torsional wave 134B, and the estimate of the time location tₑ₁ of the longitudinal wave indicator 144A is determined by dividing the target distance by the speed of the longitudinal wave 134A. The controller 120 may then process the samples 143′ of the response signal 143 containing the longitudinal wave indicator 144A at a time location t′ₑ₁ that is earlier in time and near the estimated time location tₑ₁ to identify the longitudinal wave indicator 144A (step 178) and use the identified longitudinal wave indicator 144A (time t₁) to calculate the longitudinal position candidate 110A (step 180). For example, the time location t′ₑ₁ may be set at a predetermined time offset 195 from the precise estimate tₑ₁, as shown in FIG. 4. In some embodiments, the predetermined time offset 195 is approximately 70 μs or more, such as 70-110 μs or around 90 μs (+/−10 μs).

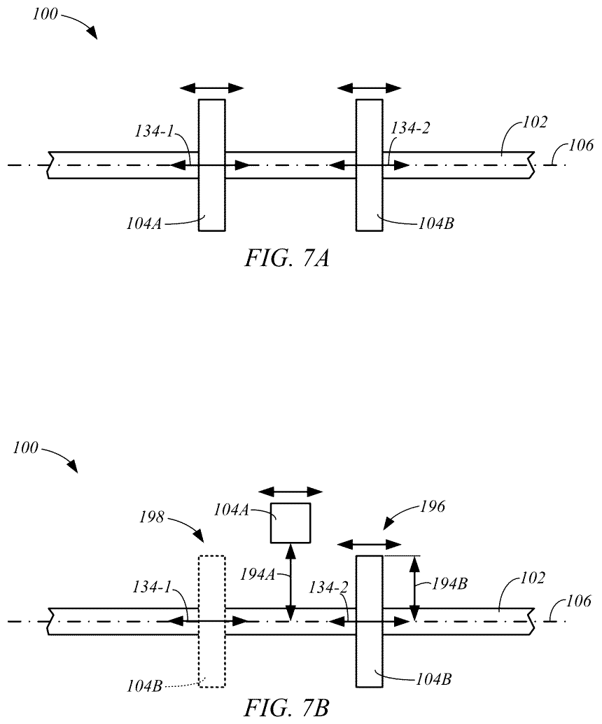

FIGS. 7A and 7B are simplified diagrams illustrating a portion of the magnetostrictive position measuring system 100 of FIG. 1, in accordance with embodiments of the present disclosure. These embodiments of the system 100 utilize a first target magnet 104A and a second target magnet 104B, both of which are configured to move along the axis 106 of the waveguide 102.

The target magnet 104A is configured to generate a magnetostrictive response 134-1 in response to an excitation signal 127 transmitted through the waveguide 102 by the excitation generator 102, and the target magnet 104B is configured to generate a magnetostrictive response 134-2 in response to the transmitted excitation signal. In some embodiments, the response signal(s) produced by the one or more sensing elements 142 include longitudinal and/or torsional wave indicators 144 that correspond to the magnetostrictive responses 134-1 and 134-2 generated by the target magnets 104A and 104B, and are distinguishable from each other by the controller 120 (e.g., the at least one processor 166).

In one embodiment, the longitudinal wave indicator corresponding to the longitudinal wave of the response 134-1 of the target magnet 104A captured in the response signal(s) 143 is used by the controller 120 to identify the longitudinal position candidate 110A of the target magnet 104A along the waveguide 102, and the torsional wave indicator corresponding to the torsional wave of the response 134-2 of the target magnet 104B captured in the response signal(s) 143 is used by the controller 120 to identify the torsional position candidate 110B of the target magnet 104B along the waveguide 102. Accordingly, the longitudinal wave indicator in the response signal(s) 143 corresponding to the target magnet 104A is distinguishable by the controller 120 from the torsional wave indicator in the response signal(s) 143 corresponding to the target magnet 104B, and the torsional wave indicator in the response signal(s) 143 corresponding to the target magnet 104B is distinguishable by the controller 120 from the torsional wave indicator in the response signal(s) 143 corresponding to the target magnet 104A. This may be accomplished using any suitable technique.

In one embodiment, the target magnets 104A and 104B are configured to produce distinct magnetostrictive responses 134-1 and 134-2 in the waveguide 102. For example, the magnetic fields 130 generated by the target magnets 104A and 104B at the waveguide 102 may have different strengths. As a result, the longitudinal and/or torsional wave indicators in the response signal(s) 143 corresponding to the responses 134-1 and 134-2 of the target magnets 104A and 104B may be identified and distinguished from each other by the controller 120 and/or the signal conditioner 146 (e.g., filter) based on their amplitude and/or frequency.

The distinct magnetic field strengths of the target magnets 104A and 104B at the waveguide 102 may be achieved through the use of target magnets 104A and 104B having different magnetic properties (FIG. 7A), and/or by locating the target magnets 104A and 104B at different radial distances 194A and 194B from the waveguide 102, as shown in FIG. 7B.

For a given target magnet 104, the longitudinal wave indicator generated by the target magnet in a response signal 143 generally has a higher amplitude than the torsional wave indicator generated by the same target magnet. Accordingly, in some embodiments, the target magnet 104A, which is configured to produce the distinct longitudinal wave indicator in the response signal(s) 143 may be configured to produce a weaker magnetic field at the waveguide 102 than the target magnet 104B, which is configured to produce the distinct torsional wave indicator in the response signal(s) 143. The target magnet 104A may produce the weaker magnetic field at the waveguide 102 due to its magnetic properties (FIG. 7A) and/or by displacing the target magnet 104A a greater radial distance 194A from the waveguide 102 than the radial distance 194B of the target magnet 104B (FIG. 7B), for example.

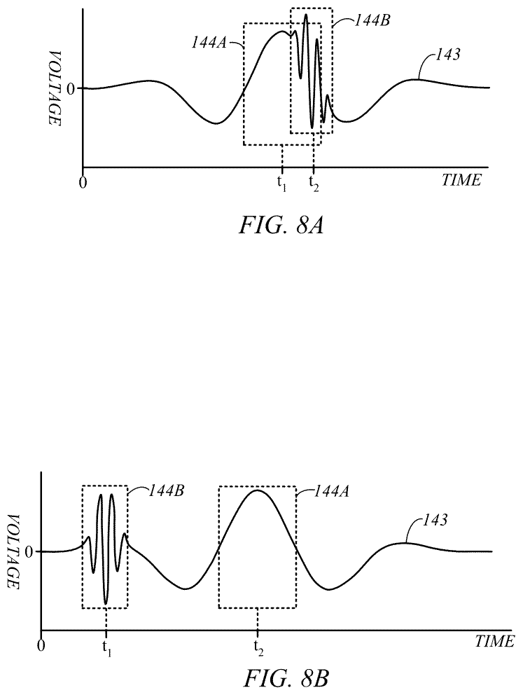

In some embodiments, the target magnets 104A and 104B are configured to move past each other along the axis 106 of the waveguide 102. Accordingly, the target magnet 104B may be positioned on a side 196 of the target magnet 104A, as shown in FIG. 7B. This may produce the response signal(s) 143 shown in FIG. 4, in which the longitudinal wave indicator 144A corresponds to the response 134-1 generated by the target magnet 104A and the torsional wave indicator 144B corresponds to the response 134-2 generated by the target magnet 104B. Additionally, the target magnet 104B may be moved relative to the target magnet 104A to a side 198, as indicated in phantom lines in FIG. 7B. This may produce the response signal(s) 143 shown in FIGS. 8A and 8B, which respectively show the longitudinal wave indicator 144A corresponding to the target magnet 104A overlapping the torsional wave indicator 144B corresponding to target magnet 104B, and the longitudinal wave indicator 104A corresponding to the target magnet 104A being received by the sensing element(s) 142 later in time (t₂) than the torsional wave indicator 144B (t₁) corresponding to target magnet 104B.

The target magnets 104A and 104B may be supported in any suitable manner along the waveguide 102 to allow for this overlapping movement. For example, the target magnets 104A and 104B may be supported on different sides of the waveguide 102, the target magnet 104B may take the form of a ring magnet that surrounds the waveguide 102, while the target magnet 104A is supported at a radial distance from the waveguide 102 that exceeds an outer diameter of the target magnet 104B, and/or the target magnets 104A and 104B may be supported in another suitable configuration.

After identifying the longitudinal wave indicator corresponding to the target magnet 104A and the torsional wave indicator corresponding to the target magnet 104B, the controller 120 may calculate the longitudinal candidate position 110A for the target magnet 104A based on the longitudinal wave indicator, and the torsional candidate position 110B for the target magnet 104B based on the torsional wave indicator, such as by using the techniques discussed above. The controller 120 may output the calculated positions 110A and 110B, as indicated in FIG. 2.

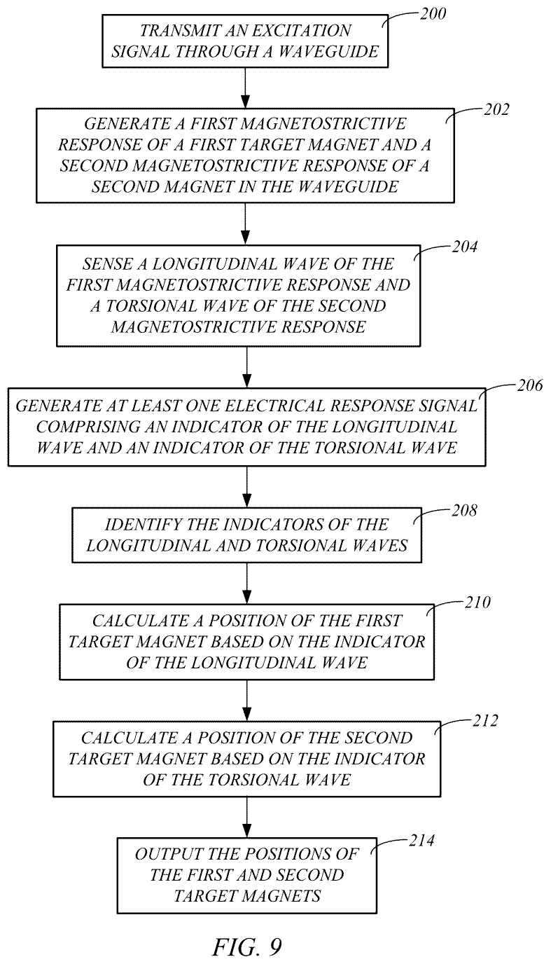

FIG. 9 is a flowchart illustrating an example of a method of operating the system 100 having first and second target magnets 104A and 104B, in accordance with embodiments of the present disclosure. At 200, an excitation signal 127 is transmitted through the waveguide 102 using an excitation generator 122. At 202, in response to the excitation signal 127, a first magnetostrictive response 134-1 of the first target magnet 104A comprising a longitudinal wave and a second magnetostrictive response 134-2 of the second target magnet 104B comprising a torsional wave are generated in the waveguide 102. In some embodiments, the first and second magnetostrictive responses 134-1 and 134-2 are distinct from each other, as discussed above, such as by using target magnets having distinct magnetic properties and/or by displacing the target magnets at different radial distances from the waveguide 102.

At 204, the longitudinal wave of the magnetostrictive response 134-1 and the torsional wave of the magnetostrictive response 134-2 are sensed in the waveguide 102 using the one or more sensing elements 142. At 206, at least one electrical response signal 143 is generated using the sensing element(s) 142 in response to the sensing step 204. The at least one electrical response signal 143 comprises a longitudinal wave indicator 144A corresponding to the longitudinal wave and a torsional wave indicator 144B corresponding to the torsional wave (FIGS. 4, 8A and 8B).

At 208 of the method, the longitudinal wave indicator 144A and the torsional wave indicator 144B in the electrical response signal(s) are identified using the controller 120, such as using the techniques described above. At 210, the controller 120 calculates the longitudinal candidate position 110A of the first target magnet 104A along the longitudinal axis 106 based on the identified longitudinal wave indicator 144A, and calculates the torsional candidate position 110B of the second target magnet 104 along the longitudinal axis 106 based on the identified torsional wave indicator 144B, at 212. The calculated positions 110A and 110B may then be output by the controller 120 at 214.

Although the embodiments of the present disclosure have been described with reference to preferred embodiments, workers skilled in the art will recognize that changes may be made in form and detail without departing from the spirit and scope of the present disclosure.

Functions recited herein may be performed by a single controller or processor, multiple controllers or processors, or at least one controller or processor. As used herein, when one or more functions are described as being performed by a controller (e.g., a specific controller), one or more controllers, at least one controller, a processor (e.g., such as a specific processor), one or more processors or at least one processor, embodiments include the performance of the function(s) by a single controller or processor, or multiple controllers or processors, unless otherwise specified. Furthermore, as used herein, when multiple functions are performed by at least one controller or processor, all of the functions may be performed by a single controller or processor, or some functions may be performed by one controller or one processor, and other functions may be performed by another controller or processor. Thus, the performance of one or more functions by at least one controller or processor does not require that all of the functions are performed by each of the controllers or processors.

What is claimed is:

1. A magnetostrictive position measuring system comprising:
a waveguide having a longitudinal axis;
an excitation generator configured to transmit an excitation signal through the waveguide;
a target magnet that is moveable along the longitudinal axis relative to the waveguide and is configured to generate a magnetostrictive response in the waveguide in response to the excitation signal, the magnetostrictive response including a longitudinal wave and a torsional wave;
one or more sensing elements configured to generate at least one electrical response signal comprising a longitudinal wave indicator, which is generated in response to the longitudinal wave, and a torsional wave indicator, which is generated in response to the torsional wave; and
a controller connected to the one or more sensing elements and configured to:
process the at least one electrical response signal to:
identify the longitudinal wave indicator; and
identify the torsional wave indicator;
calculate a first candidate position of the target magnet along the longitudinal axis based on the longitudinal wave indicator;
calculate a second candidate position of the target magnet along the longitudinal axis based on the torsional wave indicator; and
generate an output based on the first and second candidate positions.

2. The magnetostrictive position measuring system according to claim 1, wherein the controller is configured to:
compare the first and second candidate positions; and
generate the output based on the comparison of the first and second candidate positions.

3. The magnetostrictive position measuring system according to claim 2, wherein the controller is configured to:
estimate a time location of the torsional wave indicator in the at least one electrical response signal based on the identified longitudinal wave indicator; and
process the at least one electrical response signal beginning from a time location that is based on the estimated time location of the torsional wave to identify the torsional wave indicator.

4. The magnetostrictive position measuring system according to claim 3, wherein the controller is configured to:
analyze samples of the at least one electrical response signal to identify the longitudinal wave indicator; and
analyze samples of the at least one electrical response signal beginning from the estimated time location to identify the torsional wave indicator.

5. The magnetostrictive position measuring system according to claim 2, wherein the controller is configured to:
estimate a time location of the longitudinal wave indicator in the at least one electrical response signal based on the identified torsional wave indicator; and
process the at least one electrical response signal beginning from a time location that is based on the estimated time location of the longitudinal wave to identify the longitudinal wave indicator.

6. The magnetostrictive position measuring system according to claim 2, wherein the output includes an indication of at least one of a match between the first and second candidate positions and a mismatch between the first and second candidate positions.

7. The magnetostrictive position measuring system according to claim 2, wherein the output includes an indication of at least one of a degree of match between the first and second candidate positions and a degree of mismatch between the first and second candidate positions.

8. A method performed by a magnetostrictive position measuring system to determine a position of a target magnet that is moveable relative to a waveguide along a longitudinal axis of the waveguide, the method comprising:
transmitting an excitation signal using an excitation generator through the waveguide toward the target magnet;
generating, in response to the excitation signal, a magnetostrictive response of the target magnet in the waveguide, the magnetostrictive response including a longitudinal wave and a torsional wave;
sensing the longitudinal and torsional waves in the waveguide using one or more sensing elements;
generating at least one electrical response signal using the one or more sensing elements in response to the sensing of the longitudinal and torsional waves in the waveguide, the at least one electrical response signal comprising a longitudinal wave indicator and a torsional wave indicator;
identifying the longitudinal wave indicator in the at least one electrical response signal using a controller;
identifying the torsional wave indicator in the at least electrical response signal using the controller;
calculating a first candidate position of the target magnet along the longitudinal axis based on the identified longitudinal wave indicator using the controller;
calculating a second candidate position of the target magnet along the longitudinal axis based on the identified torsional wave indicator using the controller; and
generating an output based on the first and second candidate positions using the controller.

9. The method according to claim 8, wherein:
the method includes comparing the first and second candidate positions using the controller; and
generating the output comprises generating the output based on the comparison of the first and second candidate positions.

10. The method according to claim 9, wherein identifying the torsional wave indicator comprises:
estimating a time location of the torsional wave indicator in the at least one electrical response signal based on the identified longitudinal wave indicator; and
processing the at least one electrical response signal beginning from a time location that is based on the estimated time location of the torsional wave to identify the torsional wave indicator.

11. The method according to claim 10, wherein:
identifying the longitudinal wave indicator comprises analyzing samples of the at least one electrical response signal to identify the longitudinal wave indicator; and
identifying the torsional wave indicator comprises analyzing samples of the at least one electrical response signal beginning from the estimated time location.

12. The method according to claim 9, wherein identifying the longitudinal wave indicator comprises:
estimating a time location of the longitudinal wave indicator in the at least one electrical response signal based on the identified torsional wave indicator; and
processing the at least one electrical response signal beginning from a time location that is based on the estimated time location of the longitudinal wave to identify the longitudinal wave indicator.

13. The method according to claim 9, wherein the output includes an indication of at least one of a match between the first and second candidate positions and a mismatch between the first and second candidate positions.

14. The magnetostrictive position measuring system according to claim 9, wherein the output includes an indication of at least one of a degree of match between the first and second candidate positions and a degree of mismatch between the first and second candidate positions.

15. A magnetostrictive position measuring system comprising:
a waveguide having a longitudinal axis;
an excitation generator configured to transmit an excitation signal through the waveguide;
a first target magnet that is moveable along the longitudinal axis relative to the waveguide and is configured to generate a first magnetostrictive response comprising a longitudinal wave in the waveguide in response to the excitation signal;
a second target magnet that is moveable along the longitudinal axis relative to the waveguide and is configured to generate a second magnetostrictive response comprising a torsional wave in the waveguide in response to the excitation signal;
one or more sensing elements, the one or more sensing elements configured to sense the first and second magnetostrictive responses in the waveguide and generate at least one electrical response signal, the at least one electrical response signal comprising a longitudinal wave indicator corresponding to the longitudinal wave and a torsional wave indicator corresponding to the torsional wave; and
a controller connected to the one or more sensing elements and configured to:
process the at least one electrical response signal to:
identify the longitudinal wave indicator; and
identify the torsional wave indicator;
calculate a position of the first target magnet along the longitudinal axis based on the identified longitudinal wave indicator;
calculate a position of the second target magnet along the longitudinal axis based on the identified torsional wave indicator; and
generate an output indicating the calculated positions of the first and second target magnets.

16. The magnetostrictive position measuring system according to claim 14, wherein the first target magnet is configured to move along the longitudinal axis from a first side of the second target magnet along the longitudinal axis to a second side of the target magnet along the longitudinal axis that is opposite the first side.

17. The magnetostrictive position measuring system according to claim 14, wherein:
the first target magnet is displaced from the waveguide a greater radial distance than the second target magnet; or
the first target magnet produces a weaker magnetic field at the waveguide than the second target magnet.

18. A method performed by a magnetostrictive position measuring system to determine positions of first and second target magnets along a longitudinal axis of a waveguide, the method comprising:
transmitting an excitation signal through the waveguide using an excitation generator;
generating, in response to the excitation signal, a first magnetostrictive response of the first target magnet and a second magnetostrictive response of the second magnet in the waveguide;
sensing the longitudinal and torsional waves in the waveguide using one or more sensing elements;
generating at least one electrical response signal using the one or more sensing elements in response to the sensing of the longitudinal and torsional waves in the waveguide, the at least one electrical response signal comprising a longitudinal wave indicator corresponding to the longitudinal wave and a torsional wave indicator corresponding to the torsional wave;
identifying the longitudinal wave indicator in the at least one electrical response signal using a controller;
identifying the torsional wave indicator in the at least electrical response signal using the controller;
calculating a position of the first target magnet along the longitudinal axis based on the identified longitudinal wave indicator using the controller;
calculating a position of the second target magnet along the longitudinal axis based on the identified torsional wave indicator using the controller; and
generating an output indicating the calculated positions of the first and second target magnets using the controller.

19. The method according to claim 18, wherein the first target magnet is configured to move along the longitudinal axis from a first side of the second target magnet along the longitudinal axis to a second side of the target magnet along the longitudinal axis that is opposite the first side.

20. The method according to claim 18, wherein:
the first target magnet is displaced from the waveguide a greater radial distance than the second target magnet; or
the first target magnet produces a weaker magnetic field at the waveguide than the second target magnet.
